(19) United States
(12) Patent Application Publication
(10) Pub. No.: US 2026/0337070 A1
(43) Pub. Date: Oct. 29, 2026

(54) WATER TREATMENT

(71) Applicant: KEMIRA OYJ, HELSINKI (FI)

(72) Inventors: Jaakko EKMAN, Espoo (FI); Mehrdad HESAMPOUR, Espoo (FI); Sari KRAPU, Espoo (FI); Vesa-Matti TIKKALA, Espoo (FI); Iiris JOENSUU, Espoo (FI); Marjatta PIIRONEN, Espoo (FI)

(21) Appl. No.: 19/107,061

(22) PCT Filed: Aug. 29, 2023
(86) PCT No.: PCT/EP2023/073723

§ 371 Date: Feb. 27, 2025

(30) Foreign Application Priority Data
Aug. 30, 2022 (GB) 2212533.0
Feb. 28, 2023 (FI) 20235242

(51) Int. Cl. C02F 1/72; C02F 1/00; C02F 1/76; C02F 1/78; C02F 103/28

(52) U.S. Cl. CPC C02F 1/722; C02F 1/008; C02F 1/76; C02F 1/78; C02F 2103/28; C02F 2209/006; C02F 2209/02; C02F 2209/04; C02F 2209/06; C02F 2303/04

(57) ABSTRACT

Provided herein is method of controlling biocide dosing in a water treatment system comprising dosing a biocide into water to be treated, determining rH prior to dosing of the biocide to obtain a first rH value (rH₁), determining rH after dosing of the biocide to obtain a second rH value (rH₂), determining the difference between rH₁ and rH₂, wherein the difference is the system ΔrH, comparing the system ΔrH to a pre-defined target ΔrH, wherein the pre-defined target ΔrH corresponds to a required biocidal performance in the water treatment system, and adjusting the amount of biocide that is dosed into the water based on a deviation of the system ΔrH from the target ΔrH.

### FIELD OF THE INVENTION

The present disclosure generally relates to controlling biocide dosing in water treatment systems. The disclosure relates particularly, though not exclusively, to a method of controlling biocide dosing in a water treatment system using a determined temperature- and pH-adjusted redox potential (rH). The present disclosure further relates to a water treatment system which is capable of controlling biocide dosing using a determined temperature- and pH-adjusted redox potential (rH).

### BACKGROUND OF THE INVENTION

The need for purified water is increasing rapidly around the world. Efforts are being made to produce pure water from impure water using lower concentrations of chemical biocides, including disinfectants, without, however, considerably raising the cost of the purification process. In addition, there is a need for the use of biodegradable or otherwise less harmful chemicals having fewer detrimental health effects.

Chlorine-based compounds (for example, hypochlorite, chlorine dioxide and chloramines) have traditionally been used to disinfect water, including wastewater. Chlorine-based disinfectants are quite effective against bacteria, but have lower efficiency against viruses, bacterial spores and protozoan cysts. In addition, chlorine-based disinfectants give rise to potentially toxic and mutagenic by-products, making them less desirable for use in disinfection processes.

Regulations concerning the use of chlorine-based compounds to disinfect effluent of wastewater treatment plants have become more stringent in recent years, and therefore, other non-chlorine-based disinfectants are becoming increasingly popular. In particular, organic acids such as peracetic acid and performic acid have been found to be effective broad-spectrum disinfectants.

Peracetic acid (PAA or CH₃COOOH) is commercially available as an acidic quaternary equilibrium mixture with acetic acid, hydrogen peroxide (H₂O₂), and water as illustrated in reaction (1) below:

CH₃COOH+H₂O₂ [symbol] CH₃CO—OOH+H₂O (1)

PAA has a high redox potential, and disinfection mechanisms of PAA may include the release of highly reactive oxygen species (ROS). The ROS can alter the metabolism of microbes and damage the structure of microbial cells, which occurs due to chain reactions between the ROS and biomolecules such as enzymes, lipids, structural proteins and DNA. PAA advantageously produces little to no toxic/mutagenic by-products after reaction with organic material, and degrades to acetic acid, hydrogen peroxide and water.

Performic acid (PFA or HCOOOH) is normally applied as an equilibrium mixture of PFA, water, hydrogen peroxide and formic acid, as illustrated in reaction (2) below:

CHO—OH+H₂O₂ [symbol] CHO—OOH+H₂O (2)

PFA is very unstable and typically needs to be generated on-site, shortly prior to use. The disinfection mechanisms of PFA are thought to be analogous to PAA and may include the generation of ROS. PFA is considered to be more effective in disinfection than PAA (for example, requiring lower doses and/or shorter contact times) for inactivating at least some microorganisms including E. coli and Enterococcus. This may be attributable to the higher redox potential of PFA which provides a greater capacity to oxidise contaminants. Analogously to PAA, PFA produces little to no toxic/mutagenic by-products after reaction with organic materials. PFA is fully biodegradable and degradation products of PFA include carbon dioxide and water.

In water treatment systems, the initial dosage of disinfectants is typically determined based on microbial analysis before and after addition of the biocides. The initial dosage is often maintained in the systems unless there is a significant change or deviation from the desired microbial removal rate. However, this approach does not take into account changes in process conditions which may require corresponding changes in disinfectant dose. This may result in microbial counts which exceed regulatory limits (if the required levels of disinfectant activity are not achieved) or in excess unutilised disinfectant that remains in discharged water contravening regulatory limits and increasing operational costs.

It is therefore an objective of the invention to manage more effectively the dosing of disinfectants in water treatment systems to overcome the above problems.

### SUMMARY OF THE INVENTION

Accordingly, in a first aspect, the present invention provides a method of controlling biocide dosing in a water treatment system, the method comprising:
dosing a biocide into water to be treated,
determining rH prior to dosing of the biocide to obtain a first rH value (rH₁),
determining rH after dosing of the biocide to obtain a second rH value (rH₂),
determining the difference between rH₁ and rH₂, wherein the difference is the system ΔrH,
comparing the system ΔrH to a pre-defined target ΔrH, wherein the pre-defined target ΔrH corresponds to a required biocidal performance in the water treatment system, and
adjusting the amount of biocide that is dosed into the water based on a deviation of the system ΔrH from the target ΔrH.

In a second aspect, the present invention provides a water treatment system for performing the above method, the system comprising:
at least one chamber comprising an inlet for receiving water to be treated and an outlet for discharging treated water therefrom,
a first device configured to dose a biocide into the water in the at least one chamber,
a second device configured to measure pH, ORP and temperature and to determine rH₁ and rH₂ based on the measured pH, ORP and temperature;
and a control apparatus operatively connected to the first device and second device,
wherein the control apparatus is constructed and arranged to:
receive the output data relating to the determined rH₁ and rH₂ from the second device,
determine the difference between rH₁ and rH₂, wherein the difference is the system ΔrH,
compare the system ΔrH to a pre-defined target ΔrH, wherein the pre-defined target ΔrH corresponds to a required biocidal performance in the water treatment system, and
adjust the amount of biocide that is dosed into the water based on a deviation of the system ΔrH from the target ΔrH.

Preferred features of all aspects of the present invention are defined in the dependent claims. The method and system as defined herein are particularly useful in wastewater treatment and in the treatment of process water in paper mills. The present inventors have unexpectedly found a strong correlation between ΔrH and biocidal performance in water treatment systems. Consequently, the dosing of biocide can be adjusted based on system ΔrH to ensure microbial levels are kept within desired limits, and to avoid excessive dosing of biocide which may contravene environmental regulations.

### BRIEF DESCRIPTION OF FIGURES

To assist understanding of the present disclosure and to show how embodiments may be put into effect, reference is made, by way of example only, to the accompanying Figures in which:

FIG. 1 is a schematic diagram illustrating a water treatment system according to an example of the invention.

FIG. 2 is a schematic block diagram illustrating a control apparatus according to an example of the invention.

FIG. 3 is a graph illustrating the association of ΔrH with PFA-mediated killing efficacy with PFA in water from a paper mill.

FIG. 4 is a graph illustrating the association of ΔrH with monochloramine (MCA)-medicated killing efficacy in water from a paper mill.

FIG. 5 is a graph illustrating the association of ΔrH with PFA-mediated killing efficacy in water from a wastewater treatment plant.

FIG. 6A is a line graph illustrating the correlation between ORP and concentration of residual biocide.

FIG. 6B is a line graph illustrating the correlation between rH and concentration of residual biocide.

FIG. 6C is a line graph illustrating the correlation between ΔrH and concentration of residual biocide.

### DETAILED DESCRIPTION OF THE INVENTION

Regardless of the biocidal technology, biocidal performance is primarily governed by the concentration of residual biocide. The term “concentration of residual biocide” as used herein refers to the concentration of biocide remaining after a period of contact with (or exposure to) water to be treated. Thus, if a threshold concentration of residual biocide is dynamically maintained during the disinfection process, then consistent biocidal performance will be met. However, with specific regard to the use of percarboxylic acids as biocides in wastewater treatment systems, variations in water quality and quantity, as well as numerous side reactions between the biocide and water contaminants, may reduce the concentration of residual biocide, and consequently have an adverse effect on biocidal performance. For example, when added to wastewater, PFA and PAA undergo an initial rapid consumption (i.e. instantaneous disinfectant demand) followed by a more gradual decay. Poor water quality and water contaminants may accelerate the initial consumption and subsequent decay. As a result, dosing strategies which do not take into account the conditions affecting demand and/or decay may result in insufficient biocidal performance and possible violations of regulatory microbial limits.

As mentioned above, the present invention provides a method of controlling biocide dosing in a water treatment system, the method comprising:
dosing a biocide into water to be treated,
determining rH prior to dosing of the biocide to obtain a first rH value (rH₁),
determining rH after dosing of the biocide to obtain a second rH value (rH₂),
determining the difference between rH₁ and rH₂, wherein the difference is the system ΔrH,
comparing the system ΔrH to a pre-defined target ΔrH, wherein the pre-defined target ΔrH corresponds to a required biocidal performance in the water treatment system, and
adjusting the amount of biocide that is dosed into the water based on a deviation of the system ΔrH from the target ΔrH.

“Biocide” as used herein refers to any chemical substance which is able to destroy, deter, render harmless, or exert a growth-controlling effect on any harmful organism.

In some embodiments, the biocide may comprise a disinfectant. “Disinfectant” as used herein refers to a chemical substance which is able to destroy, deter, render harmless, or exert a growth-controlling effect on at least one microorganism selected from bacteria, bacterial spores, fungi, viruses and protozoa.

The biocide may be any biocide which is capable of increasing the oxidation-reduction potential (ORP) of water when added to water. In preferred examples, the biocide comprises an oxidizing biocide. The oxidizing biocide may be selected from one or more of: monochloramine (MCA), chlorine dioxide, percarboxylic acids, alkali and alkaline earth hypochlorite salts, halogenated hydantoins such as monoclorodimethylhydantoin (MCDMH) and bromoclorodimethylhydantoin (BCDMH), chlorine gas and ozone. Preferably, the oxidizing biocide comprises a percarboxylic acid. Preferably, the percarboxylic acid comprises performic acid (PFA) and/or peracetic acid (PAA). In preferred examples, the oxidative biocide comprises PFA. In other examples, the biocide comprises a non-oxidizing biocide. The non-oxidizing biocide may comprise 2,2-dibromo-3-nitrilopropionamide (DBNPA).

As would be understood by the skilled person, rH corresponds to a pH- and temperature-adjusted oxidation-reduction potential (ORP). In one example, rH may be calculated using the following equation:

rH=2·pH+2·Eh·F/(2.3026·R·T)
where:
Eh=oxidation reduction potential measured using a standard hydrogen electrode (V)
F=Faraday constant (96485 C·mol⁻¹)
R=Gas constant 8.314 J·K⁻¹·mol⁻¹
T=temperature (K)

The pH of water may be determined using a standard pH probe or pH meter. The ORP may be measured using standard sensors or electrodes. The temperature of the water may be determined using a standard thermometer. Accordingly, determining rH in the context of the present invention may involve determining the pH, temperature and ORP at the relevant time and/or location, as discussed below. In preferred examples, the pH, temperature and ORP are determined simultaneously. In other examples, the pH, temperature and ORP are determined in quick succession (in any order) within a period of not more than 5 seconds, 10 seconds, 20 seconds, 30 seconds, 1 minute, 5 minutes or 10 minutes. In further examples, the water treatment system is maintained at a constant, set temperature such that further measurements of temperature may not be required in order to determine rH. In these examples, pH and ORP may be determined simultaneously or in quick succession as described above.

In further examples, one or more of the pH, temperature and ORP are determined online. In other examples, one or more of the pH, temperature and ORP are determined inline. In further examples, each of the pH, temperature and ORP are determined online or inline, and preferably, simultaneously. Online and inline measurements are both forms of continuous, in situ measurement. Online measurements are not made directly in the main process line, but rather in a built-in branch or by-pass (for example, a sampling loop) into which samples of the treated water are automatically fed. Inline measurements are made directly in the main process line which requires placing the relevant probe or sampling interface directly into or in line with the process flow.

In the method of the present invention, rH is determined prior to dosing of the biocide to provide a first rH value (rH₁). In the context of the present invention, determining rH₁ may require measuring each of the pH, temperature and ORP simultaneously at a given time point, or successively (in any order) within a given time period. rH₁ may be determined at any time prior to dosing of the biocide although it is preferred to minimise the time between rH₁ determination and biocide addition for improved accuracy of the method. In some examples, rH₁ is determined 30 seconds, 1 minute, 5 minutes, 10 minutes, 20 minutes, or 30 minutes prior to the time at which the biocide is dosed into the water. In these examples, rH₁ may be determined at the aforementioned times by measuring each of the pH, temperature and ORP simultaneously. Alternatively, the pH, temperature and ORP may be measured in close succession (in any order) such that the aforementioned times correspond to the average time of the three measurements. Thus, for example, if the pH is determined 35 seconds prior to biocide dosing, the temperature is determined 30 seconds prior to biocide dosing, and the ORP is determined 25 seconds prior to biocide dosing, then rH₁ may be considered to be determined at 30 seconds ((35+30+25)/3) prior to biocide dosing. If the pH, temperature and ORP are measured in succession, it is desirable that the three measurements are taken within a time period of not more than 5 seconds, 10 seconds, 20 seconds, 30 seconds, 1 minute, 5 minutes or 10 minutes. If the pH, temperature and ORP are measured in succession, the three measurements are preferably taken within a time period of not more than 10 minutes.

In other examples, rH₁ is determined immediately before dosing the biocide into the water. In a continuously flowing system, rH₁ may be determined at a location upstream of the point at which the biocide is dosed into the water. Times corresponding to those provided above may be determined on the basis of the rate of flow of water (e.g. number of m³ water flowing/minute) and the volume of the vessel through which the water will flow to the point of addition of the biocide (e.g. number of m³). Thus, for example, if after determining rH₁, water will move through a section of vessel corresponding to a volume of 10 m³ at a flow rate of 2 m³/minute prior to the addition of biocide, rH₁ will have been determined 5 minutes prior to the addition of biocide. The pH, temperature and OPR probes or sensors may accordingly be placed at appropriate locations in the water treatment system to achieve the required times of measurement.

If the temperature of a water treatment system is maintained at a constant, set level, then further measurements of temperature may not be required to determine rH₁. In these instances, in order to determine rH₁, the pH and ORP may be measured simultaneously or in succession as defined above.

In the method of the present invention, a second rH is determined after dosing of the biocide to provide a second rH value (rH₂). rH₂ may be determined after a pre-determined contact time (i.e. time after addition of biocide to water) has elapsed. In the context of the present invention, determining rH₂ at a given time point may require measuring each of the pH, temperature and ORP simultaneously at a given time point, or successively (in any order) within a given time period.

In some examples, rH₂ is determined after a contact time of from 10 seconds to 30 minutes, or from 1 minute to 5 minutes, or 5 minutes. In other examples, rH₂ is determined after a contact time of 1 second, 10 seconds, 20 seconds, 30 seconds, 1 minute, 5 minutes, 10 minutes, 20 minutes or 30 minutes. In preferred examples, rH₂ is determined after a contact time of 1 minute to 5 minutes or 3 to 5 minutes. In these examples, rH₂ may be determined at the aforementioned times by measuring each of the pH, temperature and ORP simultaneously. Alternatively, the pH, temperature and ORP may be measured in close succession (in any order) such that the aforementioned times correspond to the average time of the three measurements. Thus, for example, if the pH is determined 5 seconds after biocide dosing, the temperature is determined 15 seconds after biocide dosing, and the ORP is determined 25 seconds after biocide dosing, then rH₂ may be considered to be determined at 15 seconds ((5+15+25)/3) after biocide dosing. If the pH, temperature and ORP are measured in succession, it is desirable that the three measurements are taken within a time period of not more than 5 seconds, 10 seconds, 20 seconds, 30 seconds or 1 minute. If the pH, temperature and ORP are measured in succession, the three measurements are preferably taken within a time period of not more than 10 minutes.

In a continuously flowing system, contact times corresponding to those provided above may be determined on the basis of the rate of flow of water (e.g. number of m³ water flowing/minute) and the volume of the vessel through which the water has flown through downstream of the point of addition of the biocide (e.g. number of m³). Thus, for example, if, on addition of biocide, water moves through a section of vessel corresponding to a volume of 20 m³ at a flow rate of 2 m³/minute, the contact time at the end of the section of vessel may be calculated as 10 minutes. The pH, temperature and OPR probes or sensors may accordingly be placed at appropriate locations in the water treatment system to achieve the required times of measurement.

If the temperature of a water treatment system is maintained at a constant, set level, then further measurements of temperature may not be required to determine rH₂. In these instances, in order to determine rH₂, the pH and ORP may be measured simultaneously or in succession as defined above.

The time periods for determining rH₁ and rH₂ should be consistent with those used for determining the target ΔrH as discussed below, to enable effective control of the biocide dosing.

Once rH₁ and rH₂ have been determined, the difference between rH₁ and rH₂ is determined, where the difference is represented by ΔrH and referred to as the “system ΔrH”. ΔrH may be determined either by subtracting rH₁ from rH₂ (i.e. rH₂−rH₁) in a preferred example, or by subtracting rH₂ from rH₁ (i.e. rH₁−rH₂). Unless only absolute values are considered, the difference between rH₁ and rH₂ is determined in the same way for the system ΔrH and the pre-defined target ΔrH. In other words, if the pre-defined target ΔrH is based on rH₂−rH₁, then the system ΔrH is also to be based on rH₂−rH₁. Conversely, if the pre-defined target ΔrH is based on rH₁−rH₂, then the system ΔrH is also to be based on rH₁−rH₂.

### Target ΔrH

In the method of the invention, the system ΔrH is compared to a target ΔrH, and based on any deviation of the system ΔrH from the target ΔrH, the dosing of biocide may be adjusted to provide optimal biocidal performance. Biocidal performance refers to the killing efficacy of the biocide.

The present inventors have unexpectedly found that there is a strong, positive and consistent correlation between ΔrH and the concentration of residual biocide in water treatment systems. As mentioned above, the term “concentration of residual biocide” as used herein refers to the concentration of biocide in a system after a period of contact with (or exposure to) water to be treated. The concentration of residual biocide is indicative of the biocidal performance of the system. When the concentration of residual biocide falls, the risk of microbial growth increases. The concentration of residual biocide is itself often difficult to measure and monitor. For example, this may be due to the requirement for complex equipment. Additionally, residual biocide measurements are often based on colour reactions which may be affected by the turbidity of the water. Therefore, by obviating the need to measure the residual concentration of biocide directly, the present invention provides an advantageous method of achieving and maintaining optimal biocidal performance.

The target ΔrH is defined based on the required biocidal performance of the water treatment system in which the method of controlling biocide dosing is performed. The pre-defined target ΔrH may comprise a target ΔrH value or a target range of ΔrH values. In some examples, the target range of ΔrH values is based on acceptable tolerance limits of a target ΔrH value. In some examples, the acceptable tolerance limit may be +/−1%, 5%, 10%, or 20% of the target ΔrH value. The target ΔrH may be determined by suitable calibration methods in which varying concentrations of the relevant biocide are tested, and resulting killing efficacy and ΔrH are determined. ΔrH may be determined as described above. In establishing the target ΔrH, the time periods for determining rH₁ and rH₂ relative to the time of biocide addition at each biocide concentration tested will typically be consistent with the time periods that will be selected for determining rH₁ and rH₂ to obtain the system ΔrH. Killing efficacy may be determined by performing bacterial counts using standard methods such as agar plating and colony counting. A ΔrH value or range of values providing acceptable or required killing efficacy may then be used to define the target ΔrH.

In some examples, the target ΔrH may alternatively or additionally be defined based on a correlation between ΔrH and concentration of residual biocide. In these examples, the target ΔrH may be determined by suitable calibration methods in which varying concentrations of the relevant biocide are tested, and resulting concentrations of residual biocide and ΔrH are determined. Accordingly, the target ΔrH may correspond to an optimal concentration or range of concentrations of residual biocide providing the required biocidal performance.

In some examples, the pre-defined target ΔrH value, based on the absolute value, may be from 1 to 15, or from 10 to 15, or from 12 to 15. In other examples, the target ΔrH value, based on the absolute value, may be from 2 to 10, or from 2 to 8, or from 2 to 6, or from 2 to 4, or from 4 to 10, or from 4 to 8, or from 4 to 6, or from 6 to 10 or from 6 to 8, or from 8 to 10. In examples wherein the pre-defined target ΔrH is a range of ΔrH values, based on absolute values, the lower limit of the range may be 1 or more, and the upper limit of the range may be 15 or less. In other examples, the lower limit may be 10 or more and the upper limit may be 15 or less, or the lower limit may be 12 or more and the upper limit may be 15 or less. In further examples, the lower limit may be 2 or more and the upper limit may be 8, 6 or 4 or less; the lower limit may be 4 or more and the upper limit may be 10, 8, 6 or less; the lower limit may be 6 or more and the upper limit may be 10 or 8 or less; or the lower limit may be 8 or more and the upper limit may be 10 or less.

The target ΔrH may be relatively high in wastewater treatment systems in which significant microbial reduction is generally required. In wastewater treatment systems, the target ΔrH (either as a single value or as a range of values providing acceptable tolerance limits), based on absolute values, may be from 5 to 15. The target ΔrH may be lower in other systems such as paper production mills (paper mills). For example, in paper mills, the target ΔrH (either as a single value or as a range of values providing acceptable tolerance limits), based on absolute values, may be from 1 to 5.

When the system ΔrH (as determined by rH₂−rH₁) is lower than the pre-defined target ΔrH value or lower than the minimum value of a range of target ΔrH values, the dosing of the biocide may be increased in order to restore ΔrH to the target ΔrH value or to a value which falls within the target ΔrH range of values, and to provide sufficient biocidal performance. When the system ΔrH (as determined by rH₂−rH₁) is higher than the pre-defined target ΔrH value or exceeds the maximum value of a range of target ΔrH values, the dosing of the biocide may be decreased in order to restore ΔrH to the target ΔrH value or to a value which falls within the target ΔrH range of values, and thus preventing accumulation of unused biocide.

When the system ΔrH (as determined by rH₁−rH₂) is lower than the pre-defined target ΔrH value or lower than the minimum value of a range of target ΔrH values, the dosing of the biocide may be decreased in order to restore ΔrH to the target ΔrH value or to a value which falls within the target ΔrH range of values, and thus preventing accumulation of unused biocide. When the system ΔrH (as determined by rH₁−rH₂) is higher than the pre-defined target ΔrH value or exceeds the maximum value of a range of target ΔrH values, the dosing of the biocide may be increased in order to restore ΔrH to the target ΔrH value or to a value which falls within the target ΔrH range of values, and to provide sufficient biocidal performance.

In other examples, when the system ΔrH (as determined by rH₂−rH₁ or by rH₁−rH₂) is lower than the pre-defined target ΔrH value or below the minimum value of a range of target ΔrH values, the dosing of the biocide may be increased in order to restore ΔrH to the target ΔrH value or to a value falls within the target ΔrH range of values, and to provide sufficient biocidal performance. When the system ΔrH (as determined by rH₂−rH₁ or by rH₁−rH₂) is higher than the pre-defined target ΔrH value or exceeds the maximum value of a range of target ΔrH values, the dosing of the biocide may be decreased in order to restore ΔrH to the target ΔrH value or to a value falls within the range of target ΔrH values, and thus preventing accumulation of unused biocide. In these examples, the value of the system ΔrH, pre-defined target ΔH value, and pre-defined target range of ΔrH values are represented by the corresponding absolute values.

In some examples, the system ΔrH is monitored such that any deviation from the pre-defined target ΔrH is detected, and the dosing of the biocide is adjusted, without delay. This prevents undesirable increases in microbial growth (when the biocidal performance of the system is below an acceptable level) or excessive use of biocide (when the demand for biocide decreases). Accordingly, the system ΔrH may be determined and monitored in a continuous fashion. “Continuous” in this context means at regular intervals, without pause or interruption. In some examples, the system ΔrH is determined at regular time intervals of 1 to 60 minutes, 1 to 30 minutes, 1 to 20 minutes, 1 to 10 minutes, 1 to 5 minutes or 1 to 2 minutes. The system ΔrH may be determined every minute, every 2 minutes, every 3 minutes, every 4 minutes, every 5 minutes, every 10 minutes, every 20 minutes, or every 30 minutes.

The deviation of the system ΔrH from the target ΔrH may be of any magnitude. In some examples, the biocide dosing is adjusted when there is at least 5%, or at least 10%, or at least 20% deviation from a pre-defined target ΔrH value, or at least 1%, 2%, 5% or 10% deviation from the minimum or maximum value of a pre-defined range of target ΔrH values. This may prevent adjusting of biocide dosing when there are negligible fluctuations in system ΔrH, either due to experimental error, or due to insignificant changes in process conditions. In other examples, when there is no deviation of the system ΔrH from the target ΔrH, or less than 5%, 10% or 20% deviation from a pre-defined target ΔrH value, or less than 1%, 2%, 5% or 10% deviation from the minimum or maximum value of a pre-defined range of target ΔrH values, no adjustment in biocide dosing is performed.

The adjustment in dosing of the biocide in response to the system ΔrH may be effected by different arrangements. In some examples, biocide is fed into the water to be treated via a biocide line. The biocide line may comprise one or more pumps. When an increase in biocide dosing is required, as determined by the system ΔrH, the velocity of the one or more pumps may be increased. Conversely, when a decrease in biocide dosing is required, as determined by the system ΔrH, the velocity of the one or more pumps may be decreased. Other means for controlling biocide dosing such as valves which can be opened and closed to increased and decrease the dosing of biocide, respectively, are also envisaged.

The present inventors have unexpectedly found that ΔrH is a more effective parameter than either rH or oxidation redox potential (ORP) for determining the concentration of residual biocide and consequent biocidal performance of a water system. The correlation between ΔrH and concentration of residual biocide is significantly more robust and consistent than the correlation between rH and concentration of residual biocide, or between ORP and concentration of residual biocide. As mentioned above, a low concentration of residual biocide increases the risk for microbial growth. Increases in water temperature may also increase microbial growth resulting in increased consumption of biocide and a reduced ΔrH. An increase in organic load may also consume biocide and thus reduce ΔrH. Thus, ΔrH is sensitive to any factors affecting the concentration of residual biocide which, in turn, would affect the biocidal performance of a system.

rH and ORP may vary according to water quality and process conditions, independent of residual biocide concentration. Therefore, within a given system, rH and ORP may vary over time, and accordingly, a target based on rH or ORP which would be determined to provide an acceptable level of biocidal performance under a first set of conditions may need to be re-set periodically due to changes in the conditions. In contrast, ΔrH is a more robust indicator and tolerant of changes in water quality such that once a target ΔrH value or range of values providing an acceptable level of biocidal performance is set for a given system, the target may be maintained and used as a reference point for relatively long periods of time without further calibration.

The present inventors have additionally found that when rH₂ is determined five minutes or less after the addition of the biocide (or in continuous systems, at a distance that corresponds to 5 minutes or less after the addition of biocide), there is an improved resolution between efficient and inadequate biocidal performance, and thus, the control of biocide dosing becomes more effective when using this time frame. In particular, as described in the Examples below, the increase in ΔrH that is observed with increasing biocide dosing is greater when rH₂ is determined after a contact time of five minutes or less after the addition of the biocide as compared to when rH₂ is determined after longer contact times.

### Water to be Treated

The water to be treated in the methods of the present invention is not particularly limited, and is any water or aqueous solution in need of biocidal treatment. The water to be treated may comprise raw water (for example, surface water from a lake, sea or river), drain water, industrial water, and/or wastewater.

The wastewater may comprise municipal wastewater, industrial wastewater or a mixture thereof. In some examples, the wastewater may comprise sewage. Industrial water may include process water used in industrial processes and facilities relating to, for example, the pulp and paper industry, oil industry, gas industry, mining industry, food industry, or to any other applicable industry. In some examples, the industrial water may comprise circulation water from a paper or board mill. The water to be treated typically includes one or more contaminants such as bacteria, viruses, and other non-living organic matter.

Water that has been treated by the methods of the present invention may be discharged into the environment, undergo further purification steps, or in the case of process water, may be re-used in the same process from which it originated or in a different process. In one example, circulation water originating from a paper or board manufacturing process which has been treated with biocide according to the method of the present invention is re-used in paper or board manufacturing. In another example wastewater treated with biocide according to the method of the present invention is re-used in agriculture.

### Wastewater Treatment

In preferred examples, the method of controlling biocide dosing according to the invention may be conducted within a wastewater treatment system or plant. The wastewater to be treated may include municipal wastewater, sewage and/or industrial wastewater.

Municipal wastewater or sewage treatment generally involves the following sequential processes: preliminary, primary, secondary and tertiary treatments. These are well-known to a person skilled in the art of wastewater treatment and water purification, and are further discussed below.

A preliminary treatment may remove coarse and large suspended materials that can be easily collected from the raw sewage or wastewater, for example, by screening and/or comminution, before they damage or obstruct any pumps and sewage lines of primary treatment apparatuses.

The primary treatment is designed to remove gross, suspended and floating solids from raw sewage or wastewater. Primary treatment may include screening to trap solid objects and sedimentation by gravity to remove suspended solids (removed and collected as sludge).

After the primary treatment, the wastewater may be directed to a secondary treatment which typically includes biological treatment steps and sedimentation. Specifically, primary effluent may be subjected to an activated sludge technique in which the effluent is aerated, and aerobic microorganisms metabolise organic matter to carbon dioxide and water and reproduce to form a microbial community. Organic nitrogen compounds may be converted to ammonia and subsequently nitrate. A secondary sedimentation tank may allow the microorganisms and solid wastes to agglomerate and settle as sludge. At least some of the collected sludge (activated sludge) may then be recycled for use as an inoculum for biological treatment of further incoming wastewater.

Primary and secondary treatments are often sufficient for many purposes and not all wastewater treatment plants use tertiary treatment. Those that do use tertiary treatment achieve more stringent levels of cleanliness to meet the exacting standards that govern water reuse, especially in public water supplies. Tertiary treatment is also beneficial when facilities must discharge water into sensitive or fragile ecosystems (for example, estuaries, low-flow rivers, coral reefs, etc). Tertiary treatment may include filtration, disinfection and removal of nitrogen and phosphorus.

In preferred examples, the biocide is dosed into the wastewater after the secondary treatment. The dosing of biocide may be considered a tertiary treatment. rH₁ and rH₂ are accordingly determined prior to and after biocide dosing. The biocide may alternatively or additionally be dosed into the water in an influent or effluent of primary treatment, or in an influent or effluent of secondary treatment if additional disinfection is required at these stages.

### Biocide Dosing

In continuous water systems, the biocide may be fed into the water continuously (i.e. without pause) or at regular, pre-determined time intervals. The dosing of the biocide may also be automated. By way of example, a biocide comprising a percarboxylic acid such as PFA, may be dosed into the water, for example, wastewater, at a basal dosing concentration (i.e. concentration of active biocide in the water to be treated at the point of feeding) of 1 to 2 mg/l. The basal dosing concentration of chlorine-based biocides based on total active chlorine may be from 1 to 4 mg/l in wastewater, 1 to 4 mg/l in fresh water, and 5 to 10 mg/l in paper mill process water. The basal dosing concentration may subsequently be adjusted based on changes in demands for disinfection, as determined by changes in the system ΔrH.

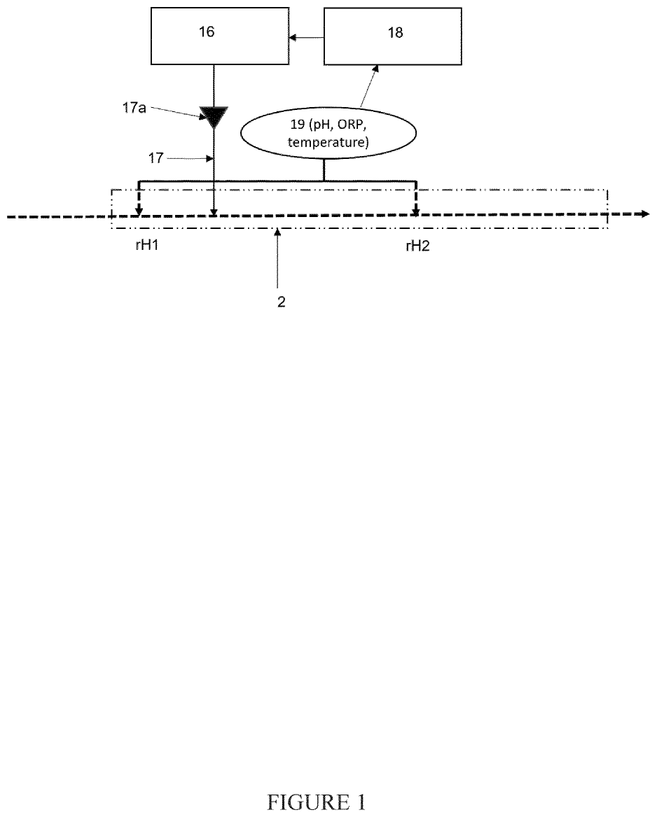

In some examples, and with reference to FIG. 1, the method of controlling biocide dosing is performed within a water treatment system 1 comprising at least one chamber 2 comprising an inlet for receiving water to be treated and an outlet for discharging treated water therefrom, a first device 16 configured to dose a biocide into the water in the at least one chamber 2 via line 17, a second device 19 configured to measure pH, ORP and temperature and to determine rH₁ and rH₂ based on the measured pH, ORP and temperature, and a control apparatus 18 operatively connected to the first device 16 and second device 19. “Device” as used herein refers to any equipment, including mechanical or electrical equipment, capable of performing the designated function, and may include a plurality of equipment. Thus, for example, the second device 19 in the system of the present invention may comprise a probe for measuring pH, a probe for measuring OPR, and a thermometer.

In preferred examples, the control apparatus 18 is constructed and arranged to: receive the output data relating to the determined rH₁ and rH₂ from the second device 19, calculate the difference between rH₁ and rH₂, wherein the difference is the system ΔrH, compare the system ΔrH to a pre-defined target ΔrH, wherein the pre-defined target ΔrH corresponds to a required biocidal performance in the water treatment system, and adjust the amount of biocide that is dosed into the water based on a deviation of the system ΔrH from the target ΔrH.

In the water treatment system, the biocide may be fed into the water in the chamber via a biocide line 17. One or more pumps or valves 17a may be present in the biocide line to control the flow of biocide into the water. When the system ΔrH deviates from the target ΔrH, the control apparatus 19 may cause an increase or decrease in the velocity of the one or more pumps or cause the one or more valves to open or close in order to adjust the dosing of the biocide into the water.

Accordingly, the control apparatus may comprise a computing apparatus. In one example, a control apparatus comprising at least one processor, and at least one memory including a computer program code is provided, the at least one memory and the computer code being configured, with the at least one processor, to cause the apparatus to perform any of the methods described herein.

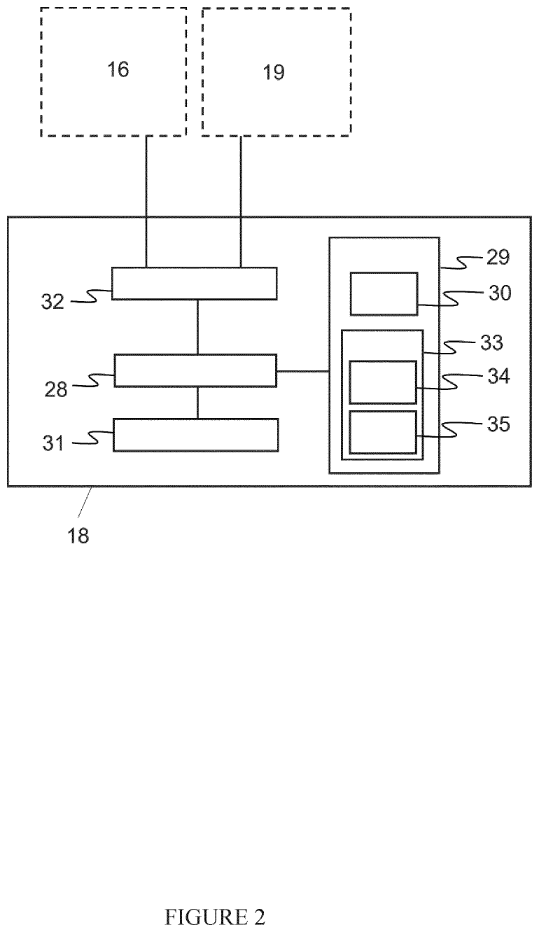

FIG. 2 is a block diagram of control apparatus 18 according to an example of the invention. The control apparatus 18 is suitable for implementing at least some of the operations described herein. With specific reference to FIG. 2, the control apparatus 18 may comprise at least one processor 28, at least one memory 29, a communication interface 32 and a user interface 31. The control apparatus may further comprise other internal circuitry and components necessary to perform the tasks described herein. The control apparatus 18 may be constructed and arranged to receive output data including system ΔrH measurements from the second device 19 and to regulate the feeding of biocide from the first device 16. In some examples, the control apparatus 18 may be constructed and arranged to monitor system ΔrH and to adjust the dosing of the biocide based on the monitored ΔrH.

The control apparatus 18 may comprise a communication interface 32 for connecting the control apparatus to a data communications system and enabling data communications with the apparatus. The communication interface 32 may comprise a wired and/or wireless communication circuitry, such as Ethernet, Wireless LAN, Bluetooth, GSM, CDMA, WCDMA, LTE, 5G circuitry, and/or analog. The communication interface can be integrated in the control apparatus 18 or provided as a part of an adapter, card or the like, that is attachable to the control apparatus 20. The communication interface 32 may support one or more different communication technologies. The control apparatus 18 may also or alternatively comprise more than one communication interface 32.

The user interface 31 may comprise a circuitry for receiving input from a user of the control apparatus 18, for example, via a keyboard, graphical user interface shown on the display of the apparatus, speech recognition circuitry, or an accessory device, such as a headset, and for providing output to the user via, for example, a graphical user interface or a loudspeaker. The control apparatus may be operated remotely.

The at least one processor 28 may be coupled to the at least one memory 29. The at least one processor 28 may be configured to execute an appropriate computer program code to implement one or more of the aspects described herein. The at least one processor 28 may be a central processing unit (CPU), a microprocessor, a digital signal processor (DSP), a graphics processing unit, an application specific integrated circuit (ASIC), a field programmable gate array, a microcontroller or a combination of such elements.

The at least one memory 29 may comprise a work memory 30 and a persistent (non-volatile, N/V) memory 33 configured to store computer program code 34 and data 35. The memory 33 may comprise any one or more of: a read-only memory (ROM), a programmable read-only memory (PROM), an erasable programmable read-only memory (EPROM), a random-access memory (RAM), a flash memory, a data disk, an optical storage, a magnetic storage, a smart card, a solid state drive (SSD), or the like. The control apparatus 18 may comprise other possible components for use in software- and hardware-aided execution of tasks it is designed to perform.

The control apparatus 18 may comprise a plurality of memories 33. The memory 33 may be constructed as a part of the control apparatus 18 or as an attachment to be inserted into a slot, port, or the like of the apparatus 18 by a user or by another person or by a robot. The memory 33 may serve the sole purpose of storing data, or be constructed as a part of an apparatus 18 serving other purposes, such as processing data.

The skilled person would understand that in addition to the elements shown in FIG. 2, the control apparatus 18 may comprise other elements, such as microphones, displays, as well as additional circuitry such as an input/output (I/O) circuitry, memory chips, application-specific integrated circuits (ASIC), a processing circuitry for specific purposes such as a source coding/decoding circuitry, a channel coding/decoding circuitry, a ciphering/deciphering circuitry, and the like. Additionally, the control apparatus 18 may comprise a disposable or rechargeable battery (not shown) for powering the apparatus 18 if an external power supply is not available. Further, it is noted that only one apparatus 18 is shown in FIG. 1, but certain embodiments may equally be implemented in a cluster of shown apparatuses.

In some examples, the control apparatus 18 may be configured to receive input of specific parameters, for example, a pre-defined target ΔrH which, as discussed above, may be a single value of ΔrH, or a range of ΔrH values. The specific parameters may be input through the user interface 31. In these embodiments, based on output data received from the second device 19, the control apparatus 18 may detect a deviation of the system ΔrH from the pre-defined target ΔrH.

If the system ΔrH falls below a pre-defined target ΔrH value or below the minimum value of a range of target ΔrH values (where ΔrH is determined by rH₂−rH₁), as could occur when there is an increased demand for disinfection, the control apparatus 18 may accordingly cause the first device 16 to increase the amount of biocide that is fed to the water to be treated over a given period of time to restore the concentration of residual biocide, and consequently, the system ΔrH, to the pre-defined target. This may be effected, as described above, by increasing the velocity of one or more pumps 17a in biocide feeding line 17, or by opening one or more valves 17a in biocide feeding line 17.

Conversely, if the system ΔrH exceeds a pre-defined target ΔrH value or the maximum value of a range of target ΔrH values (where ΔrH is determined by rH₂−rH₁), as could occur when there is an decreased demand for disinfection, the control apparatus 18 may accordingly cause the first device 16 to decrease the amount of biocide that is fed to the water to be treated over a given period of time to restore the concentration of residual biocide, and consequently, the system ΔrH, to the pre-defined target. This may be effected, as described above, by decreasing the velocity of one or more pumps 17a in biocide feeding line 17, or by closing one or more valves 17a in biocide feeding line 17.

Corresponding control measures would be applied where ΔrH is determined by rH₁−rH₂.

An appropriate computer program code 34, as executed by the processor 28 and stored in memory 29, may determine, based on output measurement data received from the second device 19, whether the system ΔrH is deviates from the pre-defined target ΔrH, and the required adjustment in the amount of biocide that is fed to the water in order to restore ΔrH to the pre-defined target ΔrH, as described herein. Accordingly, the control apparatus 18 may be constructed and arranged to compare the system ΔrH with the pre-defined target ΔrH, and may be constructed and arranged to adjust the performance of the first device 16.

In an example of the invention, the at least one processor 28 may comprise a proportional-integral-derivative (PID) controller. A PID controller is a control loop mechanism employing feedback that is widely used in industrial control systems and in a variety of other applications requiring continuously modulated control. The PID controller may continuously calculate an error value as the difference between the pre-defined ΔrH and the system ΔrH, and may subsequently apply a correction based on proportional, integral, and derivative terms. The controller may attempt to minimize the error over time by adjustment of its output (for example, by adjustment of the velocity of the one or more pumps 17a) such that the pre-defined target ΔrH can be maintained. In another example, a PI (proportional, integral)-based controller is used.

In systems specifically utilising a biocide comprising PFA, due to the instability and fast decomposition times of PFA, PFA may need to be generated immediately before use. Preferably, PFA may be generated by the first device in situ (i.e. within the water treatment system itself). As such, the first device of the water treatment system may comprise a reaction vessel in which PFA is produced. In other embodiments, PFA may be produced outside the water treatment system and transferred directly and rapidly to the first device for feeding to water. A preferred preparation method of PFA comprises mixing formic acid with hydrogen peroxide according to reaction (2) below optionally, in the presence of an acid catalyst such as sulphuric acid, ascorbic acid, or boric acid. The equilibrium of reaction (2) may be shifted in favour of PFA formation if the molar ratio of formic acid to hydrogen peroxide is increased, or by removing water from the reaction.

CHO—OH+H₂O₂⇄CHO—OOH+H₂O (2)

A commercially available device for generating and delivering PFA is KemConnect™ DEX.

Additional levels of control may be provided in systems synthesising PFA (or any other biocide) in situ. For example, when the system ΔrH is found to deviate from the pre-defined target ΔrH, and thus, an adjustment in biocide dosing is required, the adjustment may be achieved by increasing or decreasing the rate of delivery of the reagents formic acid and hydrogen peroxide to the reaction vessel to increase or decrease the rate of PFA production, respectively.

Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

The following are intended as examples only and do not limit the present disclosure.

### EXAMPLES

### Example 1—Paper Mill (PFA)

Process water from a paper mill producing board from recycled fiber was used in this test. Tests 1a and 1b were conducted on the same water but at different times. Different concentrations of biocide (PFA) were dosed into the water, and rH was determined 5 minutes after dosing and 30 minutes after dosing at each concentration of PFA tested. ΔrH was determined accordingly. Total aerobic bacterial count (by standard agar plating methods) was also determined 30 minutes after dosing. The tests were done at room temperature, +22 °C.

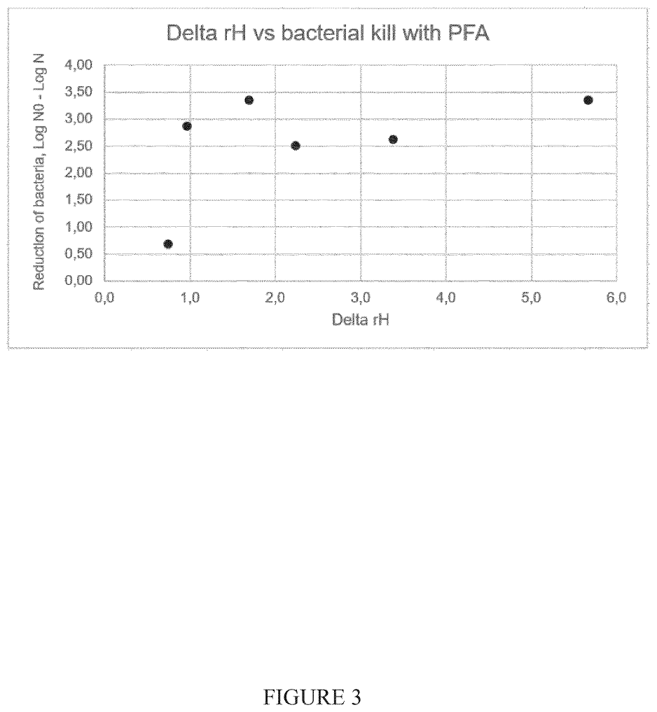

Table 1 and FIG. 3 illustrate that when ΔrH is 1.0 or more in the PFA-treated samples, the kill efficacy was >2 log units, which is adequate for this application. When ΔrH is 0.7 units, the kill efficacy is lower (<1 log unit). Accordingly, ΔrH of approximately 1 provides the optimal dose for PFA. The data also demonstrate that measuring rH 5 minutes after dosing provides improved resolution between tested doses of PFA.

TABLE 1

| PFA | ORP, 5 | ORP, 30 | | | Total | | | | | | |
|---|---|---|---|---|---|---|---|---|---|---|---|
| dose, | min | min | pH, 5 | pH, 30 | aerobic | | | | | | Killing |
| mg/l as | after | after | min | min | bacteria30 | | | | | Log | efficacy, |
| active | dosing | dosing | after | after | min after | rH | ΔrH | rH | ΔrH | aerobic | log N0- |
| PFA | (mV) | (mV) | dosing | dosing | dosing | 5 min | 5 min | 30 min | 30 min | bacteria | LogN |
| Test 1a | | | | | | | | | | | |
| 0 | 28.1 | 71.2 | 7.6 | 7.6 | 67 000 000 | 19.7 | | 21.2 | | 7.83 | |
| 3.5 | 99.5 | 121.2 | 7.5 | 7.5 | 210 000 | 21.9 | 2.2 | 22.7 | 1.5 | 5.32 | 2.50 |
| 7 | 138.6 | 114 | 7.4 | 7.4 | 160 000 | 23.1 | 3.4 | 22.2 | 1.1 | 5.20 | 2.62 |
| 14 | 211.4 | 129.9 | 7.3 | 7.3 | 30 000 | 25.4 | 5.7 | 22.6 | 1.4 | 4.48 | 3.35 |
| Test 1b | | | | | | | | | | | |
| 0 | 79.6 | 76.4 | 7.9 | 7.9 | 67 000 000 | 22.1 | | 21.9 | | 7.83 | |
| 3.5 | 101.4 | 102.9 | 7.9 | 7.9 | 14 000 000 | 22.8 | 0.7 | 22.9 | 0.9 | 7.15 | 0.68 |
| 7 | 119.4 | 111.8 | 7.7 | 7.7 | 90 000 | 23.0 | 1.0 | 22.8 | 0.8 | 4.95 | 2.87 |
| 14 | 146.7 | 130.1 | 7.6 | 7.6 | 30 000 | 23.8 | 1.7 | 23.2 | 1.2 | 4.48 | 3.35 |

### Example 2—Paper Mill (MCA)

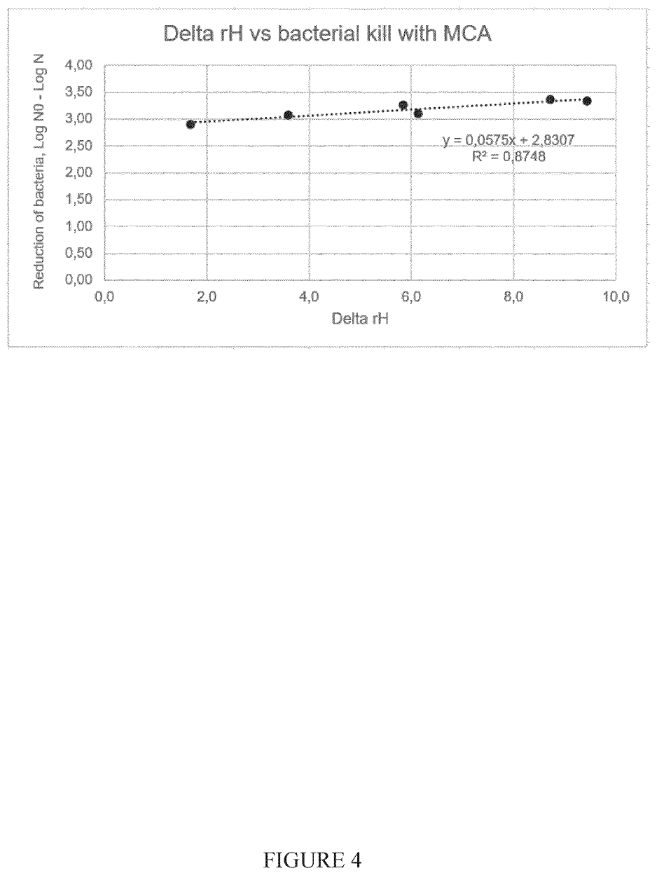

Example 1 was repeated using varying doses of MCA. The results are illustrated in Table 2 and FIG. 4.

TABLE 2

| MCA | ORP, 5 | ORP, 30 | | | Total | | | | | | |
|---|---|---|---|---|---|---|---|---|---|---|---|
| dose, | min | min | pH, 5 | pH, 30 | aerobic | | | | | | Killing |
| mg/l as | after | after | min | min | bacteria, 30 | | | | | Log | efficacy, |
| active | dosing | dosing | after | after | min after | rH | ΔrH | rH | ΔrH | aerobic | log N0- |
| chlorine | (mV) | (mV) | dosing | dosing | dosing | 5 min | 5 min | 30 min | 30 min | bacteria | LogN |
| Test 2a | | | | | | | | | | | |
| 0 | 43.2 | 57.5 | 6.1 | 6.1 | 14 000 000 | 17.3 | | 17.8 | | 7.15 | |
| 5 | 86.8 | 68.0 | 6.2 | 6.2 | 18 000 | 19.0 | 1.7 | 18.3 | 0.6 | 4.26 | 2.89 |
| 10 | 219.0 | 173.1 | 6.2 | 6.2 | 11 000 | 23.4 | 6.1 | 21.8 | 4.1 | 4.04 | 3.10 |
| 20 | 312.9 | 277.5 | 6.2 | 6.2 | 6 500 | 26.7 | 9.4 | 25.5 | 7.7 | 3.81 | 3.33 |
| Test 2b | | | | | | | | | | | |
| 0 | 55.4 | 88.8 | 6.5 | 6.5 | 12 000 000 | 18.4 | | 19.5 | | 7.08 | |
| 5 | 160.8 | 95.2 | 6.5 | 6.5 | 12 000 | 22.0 | 3.6 | 19.7 | 0.2 | 4.08 | 3.00 |
| 10 | 225.7 | 184.3 | 6.5 | 6.5 | 7 600 | 24.2 | 5.8 | 22.8 | 3.3 | 3.88 | 3.20 |
| 20 | 309.7 | 274.6 | 6.5 | 6.5 | 6 100 | 27.1 | 8.7 | 25.9 | 6.4 | 3.79 | 3.29 |

Table 2 and FIG. 4 illustrate that when ΔrH is approximately 2.0 in the MCA-treated samples, the kill efficacy was >2 log units, which is adequate for this application. Thus, ΔrH of approximately 2 provides the optimal dose for MCA. The data also demonstrate that measuring rH 5 minutes after dosing provides improved resolution between tested doses of PFA.

### Example 3—Wastewater Treatment Plant

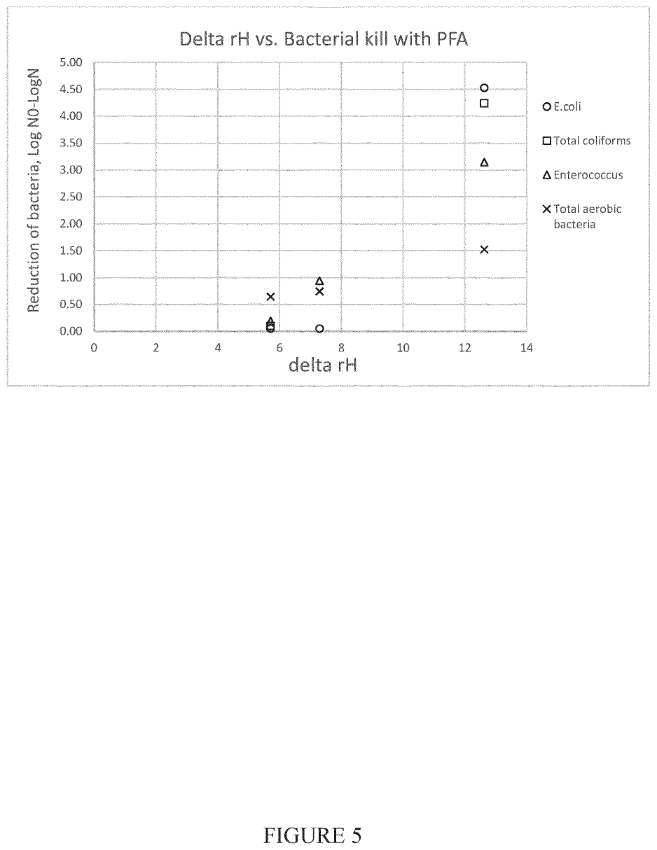

Killing efficiency tests with PFA were performed at a wastewater treatment plant which was treating both municipal and industrial wastewater. Sieved, but otherwise untreated, wastewater was treated with PFA online. A first sample was taken before PFA dosing commenced. Then 5 ppm PFA (active) was added, and OPR, pH and temperature were measured, and rH determined, 10 minutes after the addition. The PFA dosage was subsequently increased to 10 ppm, prior to determining rH again. PFA was quenched at the 10 minute sampling points to prevent further biocidal activity and changes to rH. Total coliforms, E. coli, Enterococcus and total aerobic bacteria in each sample were counted on agar plates in the following day. Tests were conducted at room temperature (+22 °C). Table 4 and FIG. 5 illustrate the results.

TABLE 4

| PFA | | | | | | | | | Total |
|---|---|---|---|---|---|---|---|---|---|
| as | | ORP | | | | Total | E. coli, | | aerobic |
| active | PH | 10 min | Temp, | | | coliform, | Log | Enterococcus | bacteria |
| mg/l | 10 min | (mV) | C | rH | ΔrH | Log red | red | Log red. | Log red. |
| 0 | 8.1 | 67 | 22 | 22.02 | | | | | |
| 5 | 8 | 240 | 22 | 27.73 | 5.71 | 0.1 | 0.05 | 0.19 | 0.64 |
| 5 | 7.8 | 298 | 22 | 29.32 | 7.29 | −0.06 | 0.05 | 0.94 | 0.74 |
| 10 | 7.1 | 495 | 22 | 34.65 | 12.6 | 4.24 | 4.52 | 3.14 | 1.52 |

It can be seen that a ΔrH value of 12.6 corresponding to 10 ppm PFA resulted in adequate killing efficiency of the measured bacteria species, and reduced pathogenic bacteria (Coliforms, E. coli, Enterococcus) to very low levels. The untreated wastewater had very high initial bacterial concentrations (data not shown) and therefore, in this system, 5 ppm active PFA resulting in ΔrH values of 5.71-7.29, was not adequate to provide the required biocidal performance.

### Example 4—Correlation Between ΔrH and Residual Biocide

Online tests were conducted within a raw water treatment plant to assess the correlation between ΔrH, rH, ORP and the concentration of residual biocide. Hypochlorite (15-25 mg/l, 15% active) and dimethyl hydantoine (10-20 mg/l, 15% active) were pre-mixed to form a halogenated hydantoin. The halogenated hydantoin was fed continuously into the water. rH was determined at locations corresponding to 1 minute before and 5 minutes after biocide addition at regular time intervals in order to establish the system ΔrH at these time points. The concentration of residual biocide and ORP were also determined after biocide addition at the same time points.

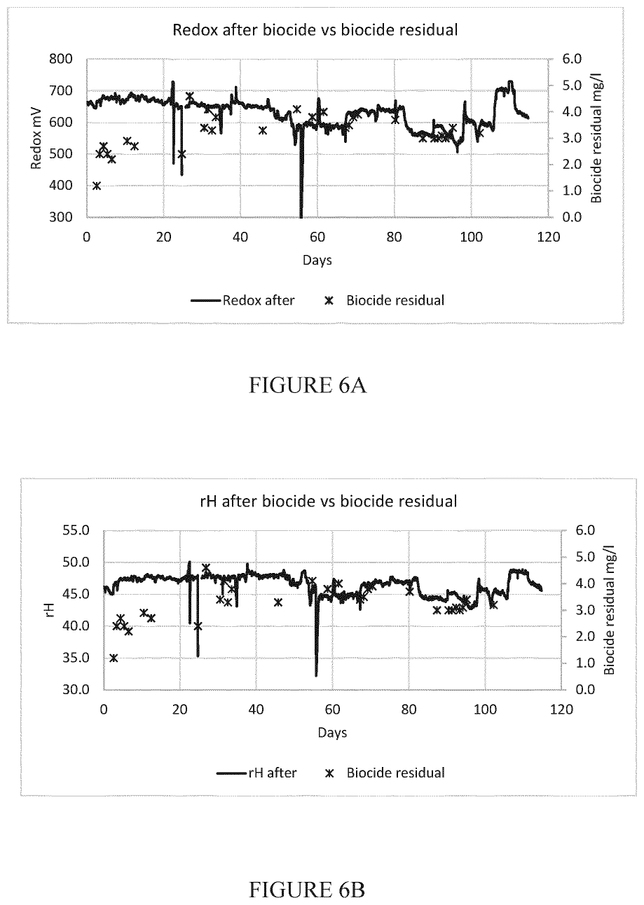

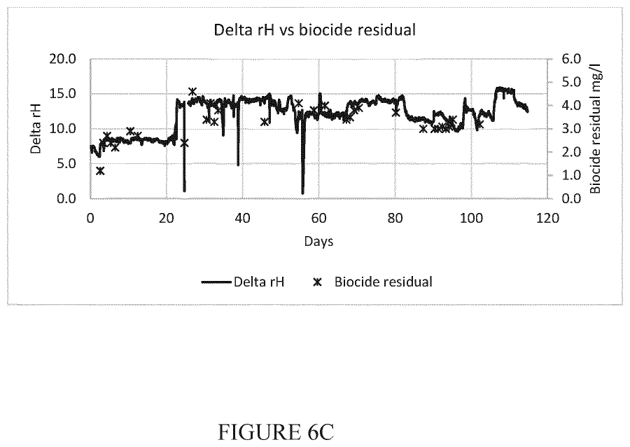

FIG. 6A illustrates that there is a poor and inconsistent correlation between ORP and concentration of residual biocide.

FIG. 6B similarly illustrates that there is a poor and inconsistent correlation between rH and concentration of residual biocide.

FIG. 6C illustrates that there is a robust and consistent correlation between ΔrH and concentration of residual biocide.

1. A method of controlling biocide dosing in a water treatment system, the method comprising:
dosing a biocide into water to be treated,
determining rH of the water to be treated prior to dosing of the biocide to obtain a first rH value (rH₁),
determining rH of the water after dosing of the biocide to obtain a second rH value (rH₂), determining the difference between rH₁ and rH₂, wherein the difference is the system ΔrH, comparing the system ΔrH to a pre-defined target ΔrH, wherein the pre-defined target ΔrH corresponds to a required biocidal performance in the water treatment system, and
adjusting the amount of biocide that is dosed into the water based on a deviation of the system ΔrH from the target ΔrH.

2. The method of claim 1, wherein the biocide comprises an oxidizing biocide.

3. The method of claim 2, wherein the oxidizing biocide is selected from monochloramine (MCA), chlorine dioxide, percarboxylic acids, halogenated hydantoins, alkali and alkaline earth hypochlorite salts, chlorine gas and ozone.

4. The method of claim 3, wherein the halogenated hydantoins comprise monoclorodimethylhydantoin (MCDMH) and bromoclorodimethylhydantoin (BCDMH),

5. The method of any of claims 2 to 4, wherein oxidizing biocide comprises a percarboxylic acid selected from performic acid (PFA) and peracetic acid (PAA).

6. The method of any preceding claim wherein the pre-defined target ΔrH comprises a pre-defined target ΔrH value or a pre-defined target range of ΔrH values.

7. The method of claim 6, wherein the pre-defined target ΔrH value is from 1 to 15, or the lower limit of a pre-defined target range of ΔrH values is 1 or more, and the upper limit of a pre-defined target range of ΔrH values 15 or less, and wherein the pre-defined target ΔrH value or pre-defined target range of ΔrH values are represented by the corresponding absolute values.

8. The method of claim 6 or claim 7, wherein the method comprises: increasing the amount of biocide dosed into the water if the system ΔrH is lower than the pre-defined target ΔrH value or lower than the minimum value of the pre-defined range of ΔrH values in order to increase the system ΔrH to the pre-defined target ΔrH value or to a value that falls within the pre-defined range of ΔrH values,
or decreasing the amount of biocide dosed into the water if the system ΔrH is higher than the pre-defined target ΔrH value or exceeds the maximum value of the pre-defined range of ΔrH values in order to decrease the system ΔrH to the pre-defined target ΔrH value or to a value that falls within the pre-defined target range of ΔrH values,
wherein the value of the system ΔrH, pre-defined target ΔH value, and pre-defined target range of ΔrH values are represented by the corresponding absolute values.

9. The method of any preceding claim, wherein rH₂ is determined when the contact time of biocide with water is from 10 seconds to 30 minutes.

10. The method of claim 9, wherein rH₂ is determined when the contact time of biocide with water is from 1 minute to 5 minutes, or from 3 to 5 minutes, or 5 minutes.

11. The method of any preceding claim, wherein the target ΔrH is defined based on a correlation between system ΔrH and residual concentration of biocide, and/or based on a correlation between system ΔrH and killing efficacy within the water treatment system.

12. The method of any preceding claim, wherein the method comprises determining the pH, oxidation reduction potential (ORP), and optionally, temperature of the water before and after the dosing of the biocide, and determining rH₁ and rH₂ based on the respective pH, temperature and ORP measurements.

13. The method of claim 12, wherein rH₁ and rH₂ are determined from the pH, ORP and temperature using the following equation (1):
rH=2·pH+2·Eh·F/(2.3026·R·T)
where:
Eh=oxidation reduction potential measured using a standard hydrogen electrode (V)
F=Faraday constant (96485 C·mol⁻¹)
R=Gas constant 8.314 J·K⁻¹·mol⁻¹
T=temperature (K)

14. The method of any preceding claim, wherein rH₁ and rH₂ are determined from inline or online measurements.

15. The method of any preceding claim, wherein the water treatment system is a continuous system, and the biocide is continually dosed into the water to be treated.

16. The method of any preceding claim, wherein the water to be treated comprises raw water, industrial water, and/or wastewater.

17. The method of claim 16, wherein the wastewater comprises municipal wastewater, wastewater derived from pulp, paper or board production, and/or wastewater derived from oil production or gas production.

18. A water treatment system for performing the method of any one of claims 1 to 17, comprising:
at least one chamber comprising an inlet for receiving water to be treated and an outlet for discharging treated water therefrom,
a first device configured to dose a biocide into the water in the at least one chamber,
a second device configured to measure pH, ORP and temperature and to determine rH₁ and rH₂ based on the measured pH, ORP and temperature;
and a control apparatus operatively connected to the first device and second device,
wherein the control apparatus is constructed and arranged to:
receive the output data relating to the determined rH₁ and rH₂ from the second device,
determine the difference between rH₁ and rH₂, wherein the difference is the system ΔrH,
compare the system ΔrH to a pre-defined target ΔrH, wherein the pre-defined target ΔrH corresponds to a required biocidal performance in the water treatment system, and
adjust the amount of biocide that is dosed into the water based on a deviation of the system ΔrH from the target ΔrH.

19. The system of claim 18, wherein the control apparatus comprises at least one processor and at least one memory including a computer program code, the at least one memory and the computer program code configured, with the at least one processor, to cause the control apparatus to receive the output data relating to the determined rH₁ and rH₂ from the second device, determine the difference between rH₁ and rH₂ to provide the system ΔrH, compare the system ΔrH to a pre-defined target ΔrH, and adjust the amount of biocide that is dosed into the water based on a deviation of the system ΔrH from the target ΔrH.
